(19) United States
(12) Patent Application Publication
(10) Pub. No.: US 2003/0064815 A1
(43) Pub. Date: Apr. 3, 2003

(54) Removable power supply module and kit for a gaming machine

(76) Inventors: John W. Burnside, Las Vegas, NV (US); Jeffrey E. Worones, Las Vegas, NV (US)

Correspondence Address: Anderson & Morishita, L.L.C., Suite 102, 2725 S Jones Blvd, Las Vegas, NV, 89146, US

(21) Appl. No.: 09/967,516

(22) Filed: Sep. 28, 2001

(51) Int. Cl. A63F 13/00

(52) U.S. Cl. 463/46; 463/47

(57) ABSTRACT

A removable power supply module and kit for an electronic machine such as a slot machine. The power supply module includes circuits to regulate a power supply to at least one output supplying the power requirements to one or more electronic components for the machine. The circuits are mounted on a substrate of the module. The module includes wings which register with guide rails disposed in the machine to guide insertion and mounting of the module in the machine. Connectors are provided between the module and the machine which mate when the module is mounted. A locking pin secures the module in the mounted position.

### FIELD OF THE INVENTION

The present invention relates to gaming machines such as slot machines and more particularly to means and apparatus for mounting the electrical power supply in the machine.

### BACKGROUND OF THE INVENTION

Electronic gaming machines, commonly referred to as slot machines have numerous electronic components as is known in the art. These components include the video monitor, processor, coin/token dispenser, cash validator, coin tester and the like. Each component has its own power requirements. According to the prior art, power, typically 110V, 3-phase and 60 amp, is brought into one or more power supply units mounted in the machine. Modernly a single power supply board is provided mounting circuits stepping the input voltage to output voltages of 5V, 12V and 24V and may alter the phase, amperage or transform the input power to direct current. The circuit board is secured within the housing by suitable fasteners such as screws.

The connectors for the various power requirements are disposed within the gaming machine housing and at the rear thereof. These connectors typically take the form of wire connectors, wire harnesses and the like. Each connector is attached to the appropriate power supply output on the board, again within the housing and at the rear thereof.

Removal and replacement of a defective or failed power supply has created several problems. One such problem is that the technician must reach into the rear of the housing often around other components to disconnect the electrical connectors from the power supply and re-connect them to the new supply. Connectors can be broken. Another problem is that the replacement of the power supply and the re-connection of the electrical connectors can be time consuming for the technician and result in the machine being out of service for a period of time.

There is a need for a new power supply and power supply connectors to overcome the problems heretofore encountered. There is also a need to provide a modular power unit which can quickly be removed and replaced and wherein mounting of the power supply automatically connects all the electronic connectors.

### SUMMARY OF THE INVENTION

There is, therefore, set forth according to the present invention a quickly removable and replaceable power supply module and mounting structure for a gaming machine of the type having a housing, a plurality of electronic components, a front opening for the housing and door to close the front opening. The module includes a substrate supporting means for regulating an input power supply to one or more outputs, the outputs connected to a first connector having a plurality of electrical contacts. The substrate also supports opposite side wings.

Disposed withing the housing is a mounting structure for the module including a pair of guide rails each disposed to slidably guide the module's insertion into the housing. The mounting structure also includes a second connector electronically coupled to various electronic components within the machine for supplying power thereto. The second connector is disposed and secured in the housing to mate with and couple to the first connector as the module is inserted into the housing as guided by the guide rails. A locking pin may be provided to lock the module in its mounted and coupled position.

To remove the module, the pin is unlocked and the module is pulled from the machine which uncouples the first and second connectors.

Thus, the power module can quickly and easily be removed from the machine and such removal uncouples the electronic connectors. A new module may be inserted by aligning the wings with the rails and sliding the module into position which also acts to couple the connectors for supplying power to the various electrical components of the machine. A locking pin locks the module in the fully inserted position signifying to the technician that the module is fully mounted and coupled in the machine. Power modules can be quickly changed speeding the time and effort necessary for the repair of the machine and reducing the time the machine is out of service. Further, electrical connectors are less likely to be damaged inasmuch as the first and second connectors according to the present invention can be made to be robust, the coupling and uncoupling occurs upon insertion and removal of the module and such coupling and uncoupling is guided by the cooperation of the side wings and guide rails.

### BRIEF DESCRIPTION OF THE DRAWINGS

These and other features and advantages will become appreciated as the same becomes better understood with reference to the description, claims and drawings wherein:

FIG. 1 shows a perspective, assembly view of the power module according to the present invention;

FIG. 2 is a front prospective view of the assembled power module;

FIG. 3 is a rear prospective view of the assembled power module;

FIG. 4 is a top view of the assembled power module;

FIG. 5 is a front view of the module support structure and guide rails; and

FIG. 6 is a side view of a mounting plate for the module.

### DESCRIPTION OF THE INVENTION

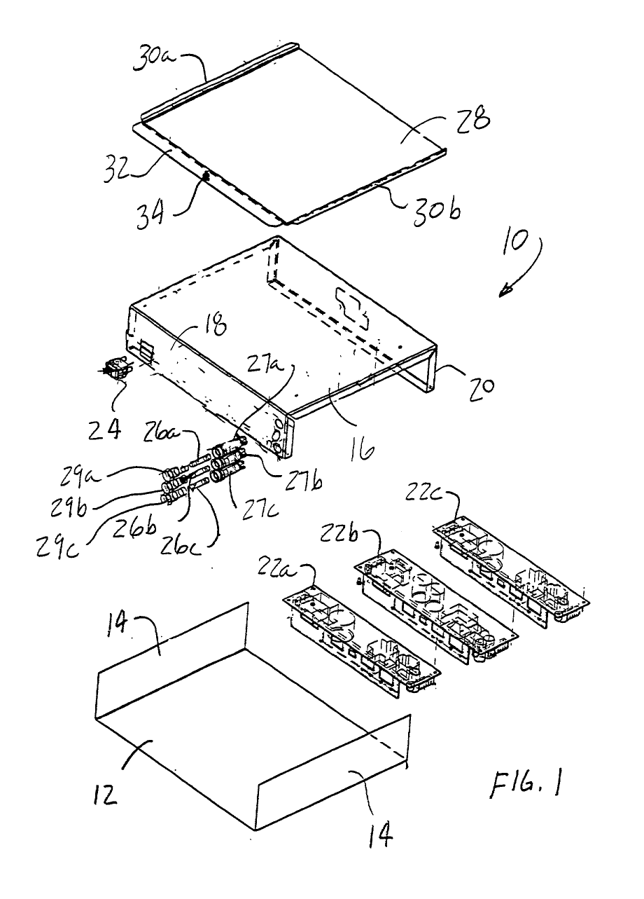

Turning to FIG. 1 there is shown an assembly view of a power module 10 according to the present invention. The power module 10 includes a bottom substrate 12 with upturned, opposing sides 14 which may be fashioned from sheet metal or any other suitable product. A top 16 has a down turned front 18 and rear 20, which may be fashioned from the same material as the substrate 12. The top 16 is secured to the substrate 12 by suitable fasteners such as screws to define a closed box-like structure suitable for containing the power regulating means for controlling the power, voltage, current or phase for operating a gaming machine. The power, current and phase requirements are known in the art or are specified by the component manufacturer. As shown, the module 10 may include three such regulating means shown as power regulating circuits 22a-c. As but an example, circuit 22a may regulate an input power supply of 10V to 24V, circuit 22b to 12V and circuit 22c to 5V.

The power module 10 also includes an on/off switch 24 for turning the power supply on and off and mounts three fuses 26a-c, one for each power regulating circuit 22a-c. Each fuse 26a-c is disposed in a fuse housing 27a-c closed by a threaded cover 29a-c.

As can be appreciated, the module 10 may be disassembled to gain access to the power regulating circuits 22a-c for repair or replacement thereof.

As shown in FIGS. 1-3, secured to the top 16 is a mounting plate 28 having oppositely projecting wings 30a, b. The wings 30a, b, where the plate 28 is disposed on the top 16, extend outward in a plane approximately parallel to that of the top 16. It should be understood that the plate 28 may be mounted to the sides 14 or bottom substrate 12 as desired so long as the wings 30a, b are presented in a projecting fashion. Further, the wings 30a,b need not be arranged in a common plane and can be offset as desired.

Still further, and in regards to the module 10, it should be understood that the module 10 need not be enclosed. Instead the power regulating circuits 22a-c may be mounted to a open, flat, substrate which may also include the wings 30a, b.

The mounting plate 28 further includes a forward projecting lip 32 which includes a locking pin 34, the purposes of which will hereinafter become evident.

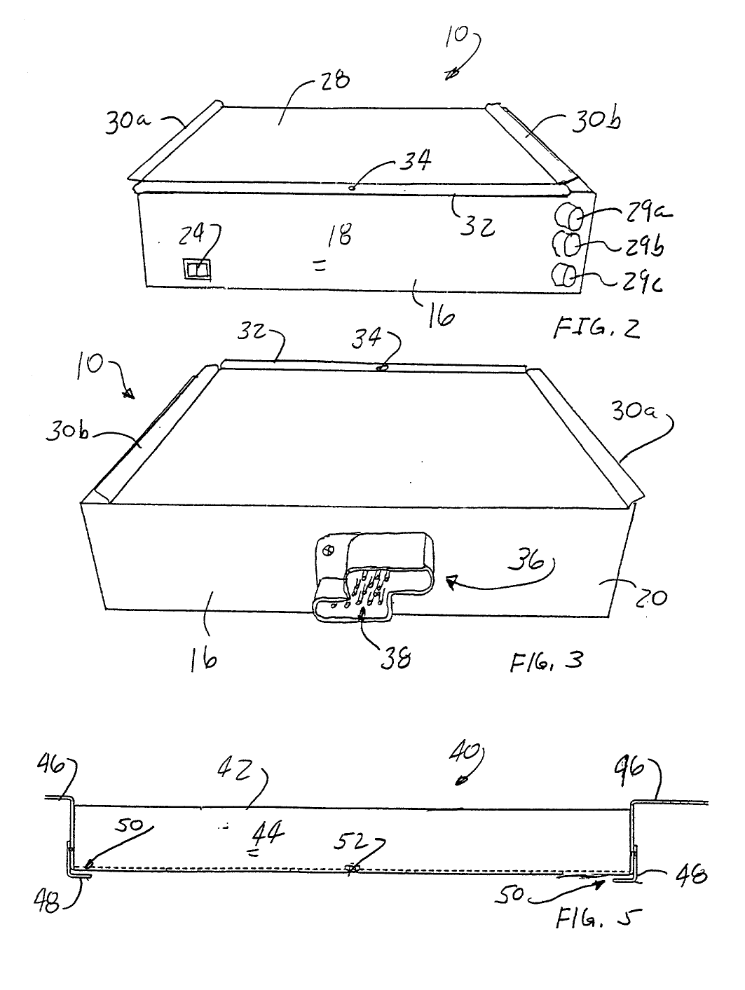

FIGS. 2 and 3 show the front and rear of the module 10 as assembled. With reference to FIG. 3 there is shown a first connector 36 secured to the outside of the rear 20 and presenting a pattern of pin contacts 38. The first connector 36 may be in an S-shape pattern or any other suitable and desirable shape. Further, more than one such connector may be provided at the rear 20. The first connector 36 and its contacts 38 define connections for the power supply and power regulating circuits 22a-c to supply input power, e.g. 110V to the power regulating circuits 22a-c and to supply regulated power from those circuits 22a-c to outside of the power module 10 for powering the various components of the gaming device.

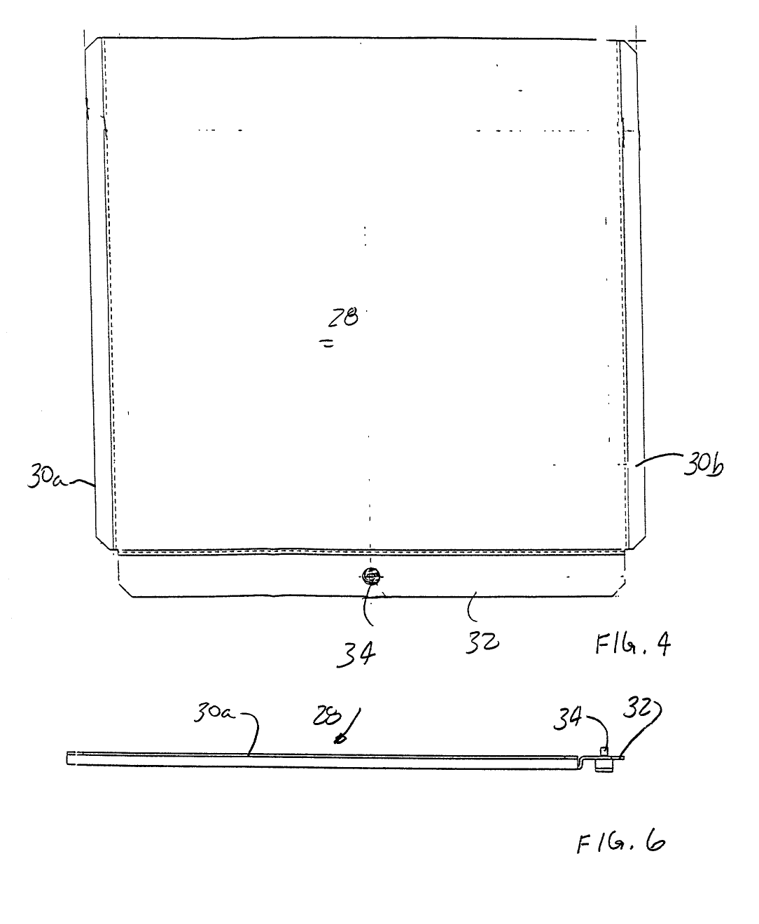

FIGS. 4A and B show a top view and side view of the mounting plate 28 and pin 34.

The power module 10 according to the present invention is adapted to be mounted into and removed from a gaming machine such as a slot machine (not shown). As is well known, these machines include various electronic components each of which may have distinct and different power requirements. These components may include a video monitor display, computer processor, cash validator, coin/token dispenser, player card reader, speakers and the like. In the prior art, power supplies may have been individually provided of commonly mounted on a substrate with wire connectors to be attached to each component. As stated above, these connectors were placed at the back of the machine housing making connecting and disconnecting them a time consuming and frustrating chore, particularly where a connector is broken or damaged and must be replaced.

In FIG. 5 there is shown a mounting structure 40 adapted to be secured within the machine housing (not shown) and to receive and mount the power module 10. The mounting structure 40 includes a shelf 42 having an upturned face 44, the shelf 42 adapted to support the video monitor for the gaming machine. Brackets 46 on either side of the shelf 42 serve to secure the shelf 42 within the machine housing. Secured to each bracket 46 is a rail 48, having a substantially L-shape cross section and defining, in cooperation with the shelf 42 a pair of spaced, substantially horizontal tracks 50 which extend in a direction from the front toward the rear within the machine housing.

While not shown, the mounting structure 40 further includes a separately located second connector of a shape to mate with the first connector 36. The electrical contacts of the second connector are in electrical contact with the power supply and with the electronic components of the gaming machine.

To install the power module 10, the wings 30a, b are aligned with the tracks 50 and the module 10 is slid along the rails 48 toward the rear of the machine. As the module 10 is moved rearwardly, the rails 48 guide the module 10 such that the first connector 36 is aligned with and mates to the second connector. Moving the module 10 to its final position fully mates the first connector 36 with the second connector and engages the pin contacts 38 with mating contacts for the second connector. In the fully engaged position, the pin 34 is inserted through a receiving bore 52 provided in the shelf 42 to lock the module 10 in position. The locking pin 34 may be threaded or spring loaded to engage and disengage from the bore 52 in the shelf. As engaged, and when turned on by the on/off switch 24, the power is provided to the power regulating circuits 22a-c and regulated power is supplied back to the machine devices through the engaged first connector 36 and second connector.

To disconnect the module 10, the on/off switch 24 is switched to the off position and the locking pin 34 is disengaged from the shelf 42. The module 10 is then pulled forward, with the wings guided by the tracks 50, from the machine uncoupling the connectors and removing the module 10.

As can be appreciated, the rails 48 and wings 30a,b support and guide the installation and removal of the module 10 from the machine as well as guide the coupling of the electrical connectors. It should be understood that the convention of front to back installation refers to the front and rear direction relative to the module 10 and that the module 10 could be installed at, for example, the side or bottom of the machine whereupon the installation would be in a side-to-side or vertical direction.

The module 10 and second connector could be provided as a kit for retrofitting exiting machines to receive the power module 10.

While we have shown and described certain embodiments of the present invention, it is to be understood that it is subject to modification without departing from the spirit and scope of the appended claims.

We claim:

1. An improved gaming machine of the type having electronic components for operation thereof, a housing with a front opening, a rear wall and a door to close the opening, the improvement comprising:
a power supply module including means for regulating an electronic input to at least one output, a substrate supporting said regulating means, a pair or oppositely projecting side wings and a first connector, said first connector including at least one contact each for supplying power to one or more components;
a support structure disposed in said gaming machine, said structure including opposed guide rails to support and slidably guide said wings as said power supply module is inserted into said machine; and
a second connector disposed to connect power from said output to said electronic components and from said input, said second connector positioned to electronically couple with the first connector contacts upon insertion of said power supply module.

2. The improved gaming machine of claim 1 further comprising a locking pin to couple said module to said support structure.

3. The improved gaming machine of claim 2 further comprising means for biasing said pin to a first position, mounting said pin on one of said module or support structure and a pin bore on the other of said module or support structure, said pin biased to engage said bore when said module is inserted and said first and second connectors are coupled.

4. The improved gaming machine of claim 1 comprising said module including said substrate and a top defining an enclosure for said regulating means.

5. A system for installation and removal from a machine including a plurality of devices having power requirements and a power source, said system comprising:
a power supply module including means for regulating power from said power source to at least one output, a substrate supporting said regulating means, a pair or oppositely projecting side wings and a first connector, said first connector including at least one contact each for supplying power to one or more devices;
a support structure disposed in said machine, said structure including opposed guide rails to support and slidably guide said wings as said power supply module is inserted into said machine; and
a second connector fixed to the machine to connect power from said output to said electronic components, said second connector positioned to electronically couple with the first connector contacts upon insertion of said power supply module into the machine.

6. The system of claim 5 further comprising a locking pin to couple said module to said support structure.

7. The improved gaming machine of claim 6 further comprising means for biasing said pin to a first position, mounting said pin on one of said module or support structure and a bore on the other of said module or support structure, said pin biased to engage said bore when said module is inserted and said first and second connectors are coupled.

8. The improved gaming machine of claim 1 comprising said module including said substrate and a top defining an enclosure for said regulating means.
